(19) United States
(12) Patent Application Publication
(10) Pub. No.: US 2022/0247806 A1
(43) Pub. Date: Aug. 4, 2022

(54) REMOTE DEVICE OPERATION USING DATA STREAM AGGREGATIONS

(71) Applicant: A2 Media Corporation, Ann Arbor, MI (US)

(72) Inventors: Robert Cleveland, Ann Arbor, MI (US); Christopher Smith, Ypsilanti, MI (US)

(21) Appl. No.: 17/587,287

(22) Filed: Jan. 28, 2022

Related U.S. Application Data
(60) Provisional application No. 63/143,343, filed on Jan. 29, 2021.

(51) Int. Cl. H04L 65/60; G06F 16/2455

(52) U.S. Cl. CPC H04L 65/60; G06F 3/0482; G06F 16/24568

(57) ABSTRACT

Remote device operation using data stream aggregations includes processing, during a performance of the event, input data streams representative of user interactions with user applications, such as to indicate levels of enthusiasm of the users with respect to occurrences within the event. Data of the input data streams are aggregated according to pooling constraints to determine data pools, which are then used to synthesize trends and trend velocities for determining an operation of a function of a remote device to cause. A signal configured to cause that operation is then transmitted to the remote device.

### CROSS-REFERENCE TO RELATED APPLICATION(S)

This disclosure claims the benefit of U.S. Provisional Application No. 63/143,343, filed Jan. 29, 2021, the entire disclosure of which is herein incorporated by reference.

### BACKGROUND

Event venues such as stadiums are built to hold thousands of audience members during live events, for example, sports matches, concerts, or the like. The audience presence within a full stadium contributes positively to the overall feel of an event both for the audience members and the people performing at the event. Similarly, low audience attendance, or an empty stadium, may negatively impact the event such as by intimating a low level of user enthusiasm or engagement.

In recent years, it has become popular to virtualize certain events, for example, for convenience, health, or safety purposes. Event virtualization allows people who would otherwise be physically present at an event venue to still participate in some way as an audience member of an event actually taking place at an event venue. In particular, the virtualization of an event may foster remote user engagement by providing some output at the event itself which the user can virtually perceive.

### SUMMARY

Disclosed herein are, inter alia, systems and techniques for remote device operation using data stream aggregations. Aspects of this disclosure include initiating, within a user application running at a user device, a user engagement with an event occurring at an event venue; generating, at the user application during a performance of the event, an input data stream representative of a user interaction with the user application, wherein the user interaction corresponds to a reaction of the user to an occurrence within the event; transmitting, from the user device, the input data stream to a server device running a server application configured to continuously receive multiple other input data streams from multiple user devices during the event; determining data pools by aggregating, at the server application, data of the input data stream and data of at least some of the multiple other input data streams according to one or more pooling constraints associated with one or both of user preferences obtained relative to the event or tag information included in the input data stream and the at least some of the multiple other input data streams; synthesizing, at the server application, trends and trend velocities within the data pools to determine to cause an operation of a function of a remote device located at the event venue during the event; and transmitting, from the server device, a signal to the remote device, wherein the signal is configured to cause the operation of the function of the remote device according to the trends and the trend velocities. The aspects of this disclosure may be methods, non-transitory computer-readable media, apparatuses, devices, systems, and/or other aspects. Those other aspects may include functionality similar to or different from the aspect described above, or as otherwise described throughout this disclosure.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram showing an example of a system for remote device operation.

FIG. 2 is a block diagram showing an example of software and environments used with a system for remote device operation.

FIG. 3 is a block diagram showing examples of functionality of a server application used with a system for remote device operation.

FIG. 4 is a block diagram showing an example workflow of a server application used with a system for remote device operation.

FIG. 5 is a block diagram showing examples of functionality of a user application used with a system for remote device operation.

FIG. 6 is a block diagram showing an example workflow of a user application used with a system for remote device operation.

FIG. 7 is a flowchart showing an example of a technique for remote device operation using data stream aggregations.

FIG. 8 is a flowchart showing an example of a technique for input data stream aggregation and synthesis.

FIG. 9 is a block diagram showing an example of a computing device which may be used in a system for remote device operation.

### DETAILED DESCRIPTION

Conventional approaches to event virtualization may not include a meaningful way for the virtual event viewers to participate in the event (e.g., by cheering for a favorite team or musical act) generally due to technical limitations. For example, although the viewing of a livestream of an event over the Internet may be an enjoyable activity, it does not amount to the feeling of being physically present at the event, cheering for one's favorite performers and participating in audience-focused activities. In many cases, event virtualization is left simply to people watching a livestream of the event over the Internet and potentially commenting their thoughts or sharing so-called “likes” over a social media platform.

One solution is to use avatars in a virtual and/or physical space to represent the event viewers. For example, event viewers attending an event virtually may register an avatar, generally an image depicting a human or humanoid, to represent them in a virtual context. That avatar may be used to participate as an audience member in some limited capacity, such as by indicating that something is “liked” or “disliked.” However, such approaches are centrally focused on allowing each avatar to represent the individual behind them as an individual in a crowd, resulting in a potentially divided audience with potentially divided reactions and other outputs. Thus, approaches which use avatars do not enable virtual crowds of users. Those approaches may further undesirably distract performers and other virtual event viewers from otherwise focusing on the event itself.

Implementations of this disclosure address problems such as these by providing a way for mobile users to interact with and indirectly control remote devices at remote locations, for example, an event venue. An intermediary location between the user and venue receives a series of disparate input streams from various user devices, in which data from those streams are aggregated into one or more data pools based on various pooling constraints related to user preferences, user demographics, or like information. The data pools are synthesized to identify trends in the data and trend velocities for those trends, which indicate increases or decreases in user engagement with an event over some period of time. Based on those trends and trend velocities, a signal is generated to cause a remote operation of a remote device located at the event venue, for example, to control the brightness or color of one or more lights, to produce a sound from one or more speakers, to cause a vibratory effect using one or more haptic devices, or the like.

The implementations of this disclosure use data stream aggregations to abstract a virtual crowd to auditory and visual outputs, in particular, by identifying trends in data streams aggregated from various different sources and using those trends to selectively operate remote devices at a remote location, for example, an event venue. In this way, rather than disaggregate outputs being presented based on each input data stream, a simultaneous aggregation of multiple input streams causes a shared output at the remote location. Event viewers can provide feedback in real-time to a software platform, for example, using audio inputs, visual inputs, sensor inputs, event-specific inputs, or a combination thereof. This enables performers to get a better sense of audience energy and respond accordingly. This further enables collection of critical data points for post-event analysis, for example, to understand how performer activity affected event viewership.

An event at which a remote device may be operated according to the implementations of this disclosure may be one or more of an e-sports match, a sports match, a concert, a festival, a press event, an educational event, a talent competition, a product launch event, a fashion show, a demonstration, an activism event, a comedy show, a public speaking engagement, or another event in which a performance or communication of some kind is involved.

An event venue at which the event is occurring refers to a location of the event and may, for example, be an arena, an event hall, an amphitheater, a stadium, a movie theater, a concert hall, or any other indoor and/or outdoor area usable for events of any size.

An event being live at an event venue refers to the event or any portion thereof occurring when an input data stream is received from a user device or otherwise processed to determine whether and how to remotely operate a remote device located at the event venue.

An occurrence at an event refers to anything that happens during the event at the event venue, for example, an intentional or unintentional action or result thereof by a performer of the event or another person or thing at the event venue during the event, whether or not the action or result is considered to be part of the event performance itself.

A performer refers to a person or computer intelligence aspect (e.g., a computer player, robot, etc.) who is indirectly or directly involved in the performance of the event, including, without limitation, an athlete, a team coach, a match referee, a musical artist, a band member, an e-sports athlete, a lecturer, a runway model, a fashion designer, an activist, a comedian, a talent show competitor, a business or product presenter, a master of ceremonies, a disk jockey, an educator, or the like.

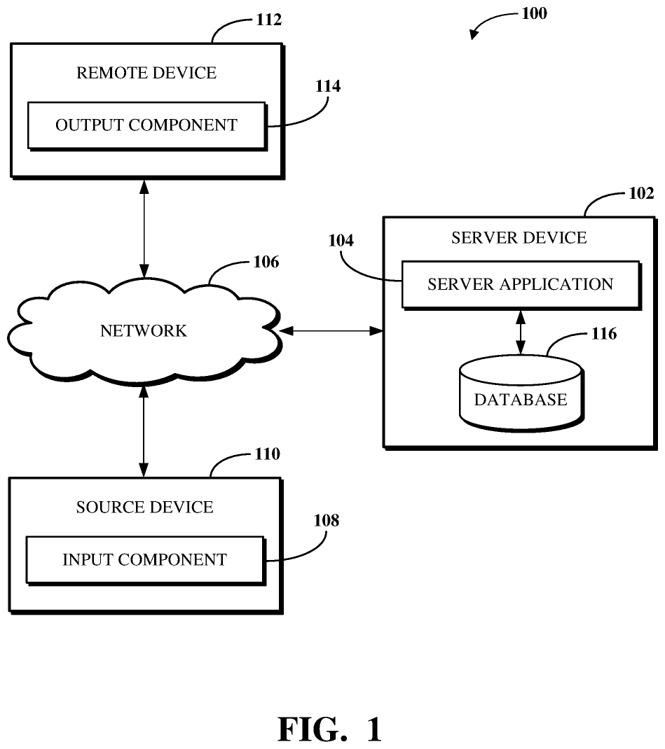

To describe some implementations in greater detail, reference is first made to examples of hardware and software structures used to implement a system for remote device operation. FIG. 1 is a block diagram showing an example of a system for remote device operation 100. The system 100 includes a server device 102 which runs a server application 104. The server application 104 processes input data streams received over a network 106 from an input component 108 of a source device 110. The server application 104 uses the processed input stream data to transmit signals over the network 106 to a remote device 112 to configure an output component 114 of the remote device 112 to operate in some way.

The server device 102 may be or include a hardware server (e.g., a server device), a software server (e.g., a web server and/or a virtual server), or both. For example, where the server device 102 is or includes a hardware server, the server device 102 may be a server device located in a rack, such as of a data center. The server application 104 is a software application used for processing input data streams received from source devices, for example, the source device 110, to determine how to operate output components of remote devices, for example, the output component 114. For example, the server application 104 may be a software application for remotely operating functionality of devices located at an event venue based on inputs received from devices of users viewing an event at the event venue.

The server application 104 accesses a database 116 on the server device 102 or another server to perform at least some of the functionality of the server application 104. The database 116 is a database or other data store used to store, manage, or otherwise provide data used to deliver functionality of the server application 104. For example, the database 106 may be a relational database management system, an object database, an XML database, a configuration management database, a management information base, one or more flat files, other suitable non-transient storage mechanisms, or a combination thereof.

The source device 110 is a computing device running a software application that collects, generates, or otherwise processes input data, for example, an input data stream, using the input component 108. For example, the source device 110 be a mobile device (e.g., a smart phone, tablet, laptop, etc.), wearable device (e.g., a smart watch, smart wristband, etc.), television (e.g., a smart television or other televisions with input components, etc.), a gaming device (e.g., a game console, a game console controller or peripheral, a gaming computer, etc.), a set-top device, a virtual reality device, a desktop device, or another computing device configured to collect, generate, or process input data.

The input data is collected, generated, or otherwise processed at the source device 110 using the input component 108, which may be, include, or otherwise refer to a motion sensor, an audio sensor, a visual sensor, or another sensor of the source device 110. For example, the input component 108 may be a motion sensor of the source device 110 (e.g., an accelerometer, a gyroscopic sensor, etc.). In another example, the input component 108 may be an image capture component (e.g., a camera) or an audio capture component (e.g., a microphone) of the source device 110. In yet another example, the input component 108 may be a user interface of the source device 110. In some implementations, the software application running at the source device 110 may use a machine learning model or other model to detect certain inputs, for example, gesture-based inputs or image object inputs within the data collected, generated, or otherwise processed using the input component 108.

The source device 110 communicates with the server device 102 over the network 106. The network 106 may, for example, be a local area network, a wide area network, a machine-to-machine network, a virtual private network, or another public or private network. The source device 110 may access the network 106 using one or more network protocols, Ethernet, TCP, IP, power line communication, Wi-Fi, Bluetooth®, infrared, GPRS, GSM, CDMA, Z-Wave, ZigBee, another protocol, or a combination thereof. The source device 110 may access the network 106 via an access point intermediary to the source device 110 and the network 106. The access point, for example, may be or include network hardware, such as a router, a switch, a load balancer, another network device, or a combination thereof. In some implementations, the access point may be omitted.

The remote device 112 is a computing device, or is otherwise a device controllable using a computing device, having one or more output components, for example, the output component 114, which can be operated to perform some functionality. The output component 114 may, for example, be, include, or otherwise refer to an audio output component, a video output component, an image output component, a lighting component, a haptic component, a motor component, a pyrotechnic component, or another output component of the remote device 112. For example, the remote device 112 may be a device with some number of LED lights and the output component 114 may be a single one of the LED lights or a panel of the LED lights. The subject LED lights may be operated, for example, by turning those lights on or off, changing a color or brightness of those lights, flashing those lights, causing those lights to depict symbols (e.g., words, numbers, emojis, etc.) or the like. In another example, the remote device 112 may be a robot, machine, or other device and the output component 114 may be a motor or motor speed which can be remotely operated to control a movement or action of the robot, machine, or other device. Generally, the remote device 112 is a device which may be present at an event venue for or during an event, whether mobile or immobile, and whether required or optional for the performance of some or all of the event.

Thus, using the system 100, the functionally of the output component 114 can be remotely operated using signals communicated to the remote device 112 from the server device 102 over the network 106. In this way, input data derived at the source device 110 may be processed at the server device 102 and used to operate functionality of the remote device 112.

In one particular example, the server application 104 is a software platform for remote fan presence and emotional energy transfer in virtual events, mixed reality, and/or other aspects of personal digital connection. The software platform enables the simultaneous collection of reactions from multiple event viewers at a given time, for example, from source devices of those event viewers, such as the source device 110. The software platform then translates those collected reactions into signals used to operate, in a specified manner, one or more remote devices located at an event venue, such as the remote device 112. For example, the software platform may collect disparate input streams from multiple source devices and process those disparate input streams to determine a specific way to operate some or all functionality of the remote device 112 and/or other remote devices located at an event venue.

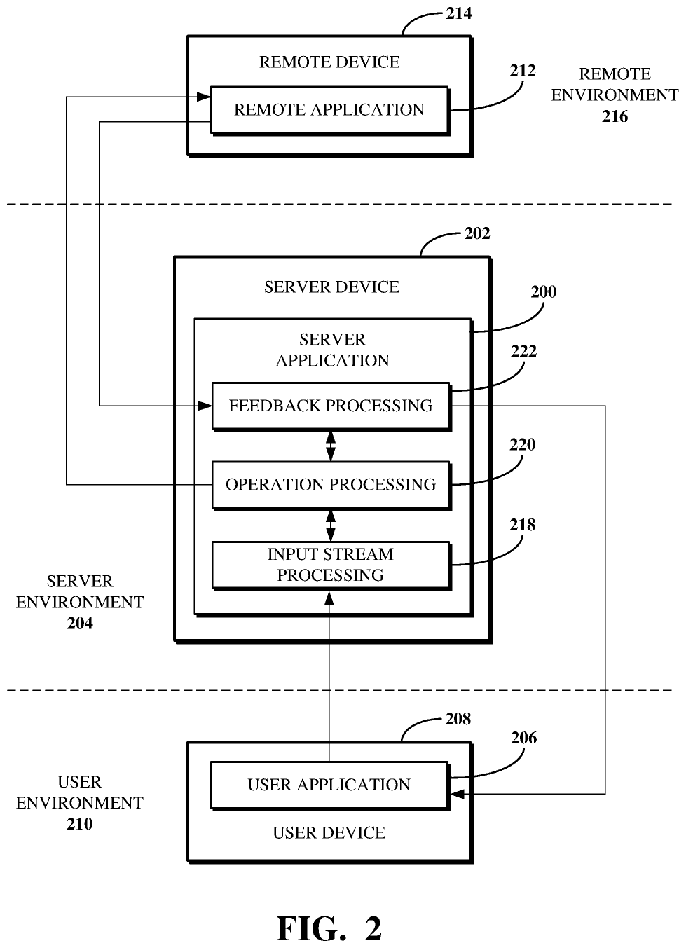

FIG. 2 is a block diagram showing an example of software and environments used with a system for remote device operation, for example, the system 100 shown in FIG. 1. As shown, a server application 200 is run on a server device 202 in a server environment 204, a user application 206 is run on a user device 208 in a user environment 210, and a remote application 212 is run on a remote device 214 in a remote environment 216.

Using the software and environments shown in FIG. 2, an input data stream received from the user device 208 can be processed at the server device 202 to determine how to operate the remote device 214 at a location remote to the user device 206. For example, the server application 200 may be the server application 104 shown in FIG. 1, the server device 202 may be the server device 102 shown in FIG. 1, the user device 208 may be the source device 110 shown in FIG. 1, and the remote device 214 may be the remote device 112 shown in FIG. 1.

The server environment 204 represents a computing environment within which the server application 200 is implemented. The server environment 204 may thus include hardware and/or software used to implement the server application 200, including but not limited to the server device 202. For example, the server environment 204 may be operated by an entity which provides the server application 200. In another example, the server environment 204 may be operated by a different entity, for example, an entity which operates a data center at which the server device 202 is located.

The user environment 210 represents a computing environment within which the user application 206 is implemented. The user environment 210 may thus include hardware and/or software used to implement the user application 208, including but not limited to the user device 206. For example, the user environment 210 may include a smart phone, game console, television, or other device which runs the user application 206. In another example, the user environment 210 may include a virtual device instantiated to run the user application 206, for example, which may be implemented using one or more web servers. The user environment 210 may include a number of user devices, including the user device 208, in which at least some of the user devices run separate installations or instances of the user application 206 or of a similar user application. For example, the user environment 210 may include thousand or even millions of user devices from which data can be received at the server application 200.

The remote environment 216 represents a computing environment within which the remote application 212 is implemented. The remote environment 216 may thus include hardware and/or software used to implement the remote application 212, including but not limited to the remote device 214. For example, the remote environment 216 may include various remote devices located at an event venue and which are configured to present some form of output using one or more output components (e.g., the output component 114 shown in FIG. 1), for example, lights, speakers, haptic elements, televisions or other screens for viewing image and/or video content, or the like. Thus, the remote environment 216 may include one or more remote devices, including the remote device 214, in which each remote device may be configured for one or more types of output.

The server application 200 includes an input stream processing aspect 218, an operation processing aspect 220, and a feedback processing aspect 222. The input stream processing aspect 218 is configured to receive and process input data streams received from multiple, different user devices, including the user device 208. For example, the input stream processing aspect 218 may be capable of processing thousands or even millions of input data streams at a given time. The input stream processing aspect 218 may be or otherwise use a massively scalable and durable real-time data streaming service to configure the server application 200 to continuously process large volumes of data per second or other unit of time. In one example, the input stream processing aspect 218 may be implemented using the Amazon® Kinesis service.

The operation processing aspect 220 uses data included in the input data streams to determine whether and how to remotely operate the remote device 214, for example, by causing a remote operation of certain functionality of the remote device 214. In particular, the operation processing aspect 220 is configured to aggregate data included in those input data streams according to one or more pooling constraints, analyze the aggregated data pools to identify trends in the respective data, determine a remote operation to perform according to those trends, and generate or otherwise cause the generation of a signal configured to cause the remote device 214 to perform the remote operation. The operation processing aspect 220 is thus configured to aggregate data from a wide set of inputs from various users of user devices to determine how to control remote devices.

The feedback processing aspect 222 receives feedback data from the remote environment 216 (e.g., from the remote application 212 or another source) indicating operations performed at the remote environment 216 based on the signals transmitted from the server application 200. The feedback processing aspect 222 then transmits that feedback data to the user application 206 for viewing by a user of the user device 208. In this way, a user of the user device 208 can receive feedback indicating how input data streams transmitted from the user device 208 to the server application 200 (along with other input data streams transmitted from other user devices to the server application 200) were used to remotely operate functionality of remote devices at the remote environment 216.

The user application 206 is a software application which uses information collected, generated, or otherwise processed at the user device 208 to produce an input data stream to be sent to the server application 200. The user application 206 may, for example, be a mobile application, a game console application, a web application, or another computer software application. The information used by the user application 206 derives from or is otherwise measured using one or more sensors or other components of the user device 208, for example, the input component 108 shown in FIG. 1. The user application 206 includes a graphical user interface (GUI) for receiving user interactions as inputs to the user application 206 and for displaying various outputs via a display of the user device 208 or another device in communication with the user device 208.

The user application 206 generally measures user enthusiasm responsive to various occurrences in an event to determine user engagement with the event. In particular, the user application 206 continuously monitors for a reaction from a user of the user application 206 to some occurrence in the event. The reaction is generally some kind of physical manifestation of an emotional response of the user to that occurrence. In this way, the user application 206 optimizes event feedback based on biomechanics which measure and quantify user enthusiasm.

The remote application 212 is a software application which processes signals received from the server application 200 to cause the remote device 214 to operate in a specified way. The remote application 212 may, for example, be software executed, interpreted, or otherwise run on a computing device in communication with the remote device 214. In some implementations, the remote application 212 may be omitted. For example, a signal communicated from the server application 200 to cause an operation of the remote device 214 may be processed using software or another processing mechanism other than a remote application running on the remote device 214. For example, a device controller or signal processor coupled to the remote device 214 may cause the operation indicated by the signal communication from the server application 200 without the execution, interpretation, or other running of a separate software application.

In some implementations, the user environment 210 may include a third party device (not shown) which runs a third party application. For example, the third party device may be a server device in a data center or other location, and the third party application may be a web application, a mobile application, or another application run through the third party device. Examples of third party applications include, without limitation, VOIP applications, messaging applications, gaming applications, social media applications, and streaming applications. The third party device is a device from which input data streams may be received by the server application 200. For example, the third party device may be a source device, such as the source device 110 shown in FIG. 1. In some such implementations, input streams received at the server application 200 from the user environment 210 may be received from one or more third party devices and from one or more user devices, including the user device 208. Alternatively, in other such implementations, the input streams may be received from one or more third party devices and not from the user device 208 or other user devices.

In some implementations, a signal transmitted from the server application 200 to cause an operation of the remote device 214 may also be transmitted to a third party for streaming. For example, a production company or other third party which is live streaming an event at an event venue at which the remote device 214 is located may receive a signal from the server application 200 indicating the particular remote device operation to be caused based on the input data streams received at the server application 200. The production company or other third party may then incorporate content into a livestream for that event to output or otherwise represent that particular remote device operation. For example, where the input data streams are processed to indicate viewer excitement for the teams of a sports match, the production company or other third party may use data communicated from the server application to show, in a livestream of the sports match, some measure of viewer excitement for those teams.

In some implementations, there may be a remote device at the event venue for each user device to represent individual outputs based on individual input data streams from those user devices. For example, some or all seats at an event venue may be equipped with one or more remote devices, such as a light, a speaker, a haptic device, or the like. Each seat with equipped devices may be associated with a single user device. In such an implementation, the data processing performed using the operation processing aspect 220 of the server application 200 may be limited or omitted. Instead, data included in the input data stream from each given user device may be uniquely used to control the individual remote devices equipped at the seat with which the user device is associated. In this way, various individual expressions can be presented within the event venue to represent the users of the user devices as individuals. In some such implementations, the remote devices may be equipped at areas of the event venue other than seats, for example, other physical aspects or areas of the event venue.

In some implementations, the event venue may be a virtual environment, such that the event is performed virtually rather than physically. For example, where an event is an e-sports match and members of the teams are each playing the subject game over the Internet from their own private locations, as opposed to being grouped together physically such as in a stadium, the event venue may refer to a virtual space embedding media streams showing video feeds of the gameplay and/or video feeds of some or all of the players. The virtual space may, for example, be a website, web application, or other platform which embeds the various media streams.

In such an implementation, the remote device 214 may refer to an element displayed or otherwise output alongside one or more such embedded streams, which element may be perceived by viewers of the event. For example, the element may be a GUI element shown alongside the embedded stream(s), such as a collection of one or more pixels regardless of location across the GUI which may be operated to cause a change in color and/or brightness of those pixels, or such as a text box which may be operated to cause a random or specific message to appear within the GUI. In another example, the element may be an audio aspect of the event venue, such as a specific sound or other noise played over an audio channel alongside the further streaming of the embedded stream(s).

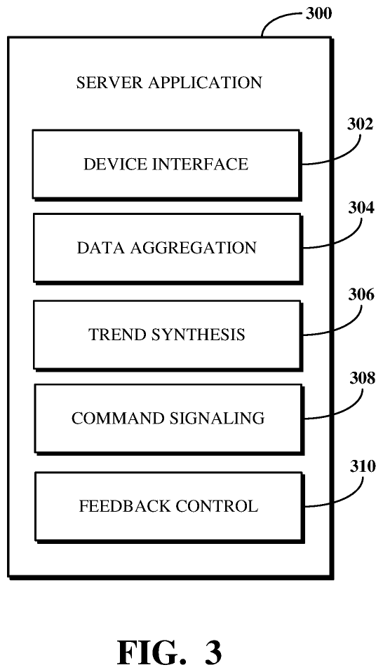

FIG. 3 is a block diagram showing examples of functionality of a server application 300 used with a system for remote device operation, for example, the server application 200 shown in FIG. 2. The server application 300 includes a device interface tool 302, a data aggregation tool 304, a trend synthesis tool 306, a command signaling tool 308, and a feedback control tool 310.

The server application 300 operates to process input data streams received from user applications, for example, the user application 206 shown in FIG. 2. The input data streams include data representing enthusiasm, preferences, or other interactions of users of the user devices relative to an event occurring live at an event venue, in which a remote device to be remotely operated using a signal from the server application 300 is located at that event venue. For example, the data of an input data stream received from a user device may measure or otherwise indicate one or more of whether a user of the user device likes or dislikes something which occurred during the live event, a degree to which the user likes or dislikes that something, a level of enthusiasm for a performer or subset of performers at the event, a preference for a performer or subset of the performers, or another aspect related to the event. The data included in the input data streams may be expressed as time series data or in one or more other data formats.

The data of an input data stream represents sensor measurements obtained using one or more sensors of user devices running the user applications. The sensor measurements of an input data stream indicate magnitudes of measurements obtained using the sensor(s) of a corresponding user device. For example, where the sensor measurements are obtained using a motion sensor, the sensor measurements may indicate a magnitude of linear acceleration of the user device, rotational acceleration of the user device, angular positionings of the user device, or the like. In another example, where the sensor measurements are obtained using an audio sensor, the sensor measurements may indicate a magnitude of a sound captured. In some implementations, the sensor measurements may be represented as binary values instead of as magnitudes, such as to indicate whether or not any measurements were obtained using the sensors of the user device. In some implementations, and as will be described below, a threshold check may be used to verify that the sensor measurements have at least a minimum value before they are included in an input data stream.

The sensor measurements of an input data stream are tagged with tag information associated with the user device from which the input data stream is received and/or a user of the user device. The tag information generally refers to user preferences and/or user demographics obtained using a user application which generates the input data stream. In particular, examples of tag information may include, but are not limited to, team or other performer affiliation, fan type, geolocation, age, gender, duration of engagement with the user application, frequency of engagement with the user application, subscription information, reward points or another score for the user (e.g., based on engagements with the user application or awarded on another basis), and others based on specific events. In at least some cases, values of at least some of the tag information types may be input by the user within the user application. For example, the user may be permitted to register a user profile within the user application to record preferences, including, for example, his or her age, gender, geolocation, favorite teams or other performers, or the like.

An input data stream may be received at the server application 300 at any time during the event. For example, a user application running on a user device may be configured to continuously monitor for and collect, generate, or otherwise process data to transmit as an input data stream for as long as the user application remains running, either in the foreground or background of the user device. In such a case, input data streams may correspond to real-time occurrences within the event, such that there may be measurable viewer response to certain occurrences within the event (e.g., a music artist performing a hit song, a favorite athlete scoring points or otherwise making a good play, an e-sports team being eliminated from a round, etc.).

In some implementations, an input data stream may be received at the server application 300 responsive to a prompt to the user, presented at the user device via the user application, for some user interaction or other input. For example, the user application, either independently or in response to instructions from the server application, may prompt a user of the user application to shake the user device to indicate a level of enthusiasm the user has for the event, a performer of the event, an occurrence at the event, or the like. In another example, the user application may prompt the user to indicate his or her favorite performer. In yet another example, the user application may be coordinated with other user applications via the server application 300 to cause a sequence of staggered input data streams to be received from different user devices, such as to trigger a staggered output (e.g., “the wave,” as is commonly known to occur at sporting events). An input data stream including data representative of the specific user interaction in any of those cases may then be transmitted from the user device for processing at the server application.

In some implementations, the server application 300 may be configured to receive input data streams which are the result of continuous monitoring for user interaction by the user application and/or which are the result of prompts for information at the user application.

Turning now to the tools of the server application 300, the device interface tool 302 is a software tool for interfacing the server application 300 with the server device which runs the server application 300, for example, the server device 202 shown in FIG. 2. For example, the device interface tool 302 can include driver information and other instructions for the processing of the server application 300 at the server device.

The device interface tool 302 may further enable communications and other cross-device functionality between the server device which runs the server application 300 and other devices used with the system for remote device operation. For example, the device interface tool 302 may enable communications between the server device and a remote device to which a signal is communicated for remote operation based on processing performed at the server application 300. The device interface tool 302 may include or otherwise use one or more application programming interfaces (APIs) associated with software in a remote environment including the remote device to facilitate exchanges of information with software running on a remote device or otherwise with software used to control a remote device.

In another example, the device interface tool 302 may enable communications between the server device and user devices from which input data streams are received and later processed to generate the signal for the remote operation of the remote device. The device interface tool 302 may use or otherwise receive data from a real-time data streaming service to facilitate exchanges of the input data streams from user applications running on those user devices to the server application 300, as well as data which is later communicated from the server application 300 to the user applications. The device interface tool 302 may include or otherwise use an API associated with the user application to facilitate those exchanges.

The data aggregation tool 304 processes data included in the input data streams received from the user devices to determine data pools using one or more pooling constraints. The data aggregation tool 304 operates to identify similarities in the data of different input data streams and aggregate the similar data for further processing. The data pools determined using the data aggregation tool 304 represent aggregations of certain data included in the received input data streams based on similarities according to the pooling constraints.

The pooling constraints are filters or other settings used to organize data of the input data streams. The data aggregation tool 304 may use categories or values of tag information as pooling constraints for aggregating the data of the various input data streams. Alternatively, or additionally, the pooling constraints may correspond to one or more of a type of the data (e.g., accelerometer data, gyroscopic data, other motion data, image or video data, audio data, etc.), geographic locations of users of the user devices from which the input data streams are received, a geographic location of an event venue at which the remote device to be remotely operated is located, a performer or subset of performers of the event occurring at the event venue (e.g., a band performing a concert, one or more teams of a sports match or an e-sports match, etc.), latency or other network considerations associated with communications with individual ones of the user devices, demographic considerations beyond geographic locations of the users of the user devices, or the like.

There many be one or more data pools resulting from the aggregation of the data of the multiple input data streams, in which each of the data pools corresponds to a particular aspect of the event occurring live at the event venue. For example, where the event is a sports match or an e-sports match, a first data pool may be determined for users who have expressed a preference for a first team of the match and a second data pool may be determined for users who have expressed a preference for a second team opposing the first team. In this way, different data pools for each of the teams may be processed and compared to evaluate whether one team has more enthusiastic fans or otherwise has a greater viewer response during the event.

In some implementations, the server application 300 may include multiple data aggregation tools 304 to address scaling or durability concerns. For example, a first data aggregation tool may operate to aggregate data of input data streams collected in a first geographic region and a second data aggregation tool may operate to aggregate data of input data streams collected in a second geographic region. Alternatively, in some implementations, separate instances of the server application 300 implemented at different locations across one or more content distribution networks may each have their own data aggregation tool 304 which are used to aggregate data of input data streams collected in certain geographic regions corresponding to those different locations. In some such implementations, regardless of whether separate data aggregation tools are used by a single instance of the server application 300 or by multiple instances thereof, a central data aggregation tool may operate to receive the data pools determined using the various data aggregation tools, and the central data aggregation tool may perform a final aggregation against those data pools to determine the final data pools to be further processed at the server application 300.

The trend synthesis tool 306 evaluates the data pools determined using the data aggregation tool 304 to synthesize trends in the data of the data pools and trend velocities for the trends. The trends and trend velocities are used to measure user reactions to occurrences within an event, for example, to determine how to use the data of the data pools to cause an operation of a remote device.

A trend refers generally to a momentary measure of aggregated input, for example, based on an evaluation of data within data pools aggregated at a given time. A trend may be a measurement of certain data according to a category of tag information associated therewith. For example, a trend may be a measurement of a magnitude of motion sensor or audio sensor measurements tagged with tag information indicating the corresponding users are fans of a particular team in a sports match or an e-sports match. In another example, a trend may be a measurement of a magnitude of motion sensor or audio sensor measurements tagged with tag information indicating a favorite song of an artist performing a concert.

A trend velocity refers generally to a change in a trend over some amount of time, for example, a rate at which certain types and/or values of data are being received at the server application 300 when comparing momentary measures of data from data pools at one time against a baseline (e.g., a normalized value, an average of past data pool values, or another baseline value). A trend velocity for a trend may increase where data pool values related to the trend are increasing in magnitude and/or cardinality over time. Similarly, a trend velocity for a trend may decrease where those data pool values instead are decreasing in magnitude and/or cardinality over time. The time period over which a trend velocity is measured may be one or more seconds, tens of seconds, or more. In some cases, a time period over which a trend velocity is measured may be less than one second or more than one minute.

The trend synthesis tool 306 thus evaluates the data included in data pools determined by the data aggregation tool 304 against previously obtained data of previously determined data pools. For example, data of data pools previously determined during an event may be retained throughout the duration of the event. In another example, such data may be purged according to an eviction policy indicating a maximum time limit for retaining the data.

The trend synthesis tool 306 may be used to measure increases in trend velocities for a threshold period of time or to determine whether a particular trend velocity has exceeded a threshold rate value. For example, a determination that either threshold condition has been met may indicate a level of user enthusiasm within the event usable to trigger an operation of a remote device. The trend velocity measurement is a useful indicator of the meaningfulness of an event occurrence to event viewers (i.e., users of the user devices), for example, because it indicates reactions to that occurrence within the event. In that the data of the data pools are expressed in a time series format, a trend velocity may be determined for a trend by comparing data values for a trend based on times signaled in the time series data.

The command signaling tool 308 generates a signal based on the trends and trend velocities determined using the trend synthesis tool 306 to cause an operation or a change in operation of a remote device located at the event venue. The signal is some piece of data that is configured to cause a remote device to operate in some way when processed either directly at the remote device or indirectly, such as at a secondary device used to control operations of the remote device. An operator of the event venue may configure the remote device to operate in certain ways in response to certain signals from the server device 300, for example, based on hardware or other limitations of the remote device. In some implementations, however, the signal may specify a particular manner by which the remote device should be operated, regardless of whether or not a default configuration has been established for the remote device.

As previously stated, the remote operation of the remote device according to the signal from the server application 300 results in a change in some aspect of the event venue. For example, one or more lights or sets of lights may be selectively turned on, turned off, flashed, changed in brightness, changed in color, or otherwise operated. In another example, a noise or other audio output may be presented at one or more speakers at the event venue.

In some implementations, a sequence of operations can be queued based on various input received from one or more users over time. For example, a sequence of operations may be associated with some output action to occur at the event venue which involves the remote operation of multiple remote devices at a single time or over some period of time. For a given sequence of operations, the server application 300 can wait until a threshold number of operations are queued before transmitting a signal to cause the output action to occur. For example, the sequence of operations may relate to causing lights to flash or robotic devices to move around an event venue from section to section (e.g., to form “the wave”). In another example, the sequence of operations may relate to a chain of remote device operations defined for the performer of the event, based on some or all of the performance of the event, or based on the event venue itself.

The particular operation to cause may be determined based on tag information associated with a trend velocity that has either consistently increased for a threshold period of time or that has exceeded a threshold rate value. For example, where a trend velocity associated with data tagged with a particular sports team preference meets either threshold condition, a signal may be generated to cause one or more lights or set of lights at the event venue to change colors to reflect the colors of that sports team, such as to indicate that it that team a highest measured fan reaction. In another example, where a trend velocity associated with data tagged with a particular geographic region (e.g., a city, county, state, province, country, etc.) meets either threshold condition, a signal may be generated to cause one or speakers at the event venue to output sound representative of that geographic region, such as to indicate that it had the highest measured fan presence for a geographic region.

In this way, the trends can trigger large, universal adjustments at the event venue itself, for example, related to a volume of audio output, a brightness or color intensity of one or more lights, a vibration of a haptic unit, and/or the like. These universal adjustments can be for one remote device at the event venue, some (i.e., more than one but fewer than all) of the remote devices at the event venue, or all of the remote devices at the event venue. Thus, while individual remote devices may operate with individual outputs at potentially different values or levels, an overall baseline for the remote devices may in at least some cases be amplified based on the trend velocity determined using the trend synthesis tool 306.

In some implementations, trend and trend velocity information can be modeled over time to predict user behavior during an event. For example, data sets indicating correspondences between event activity (e.g., a play during a sports match, a song starting or ending by a band or singer, a team being eliminated from an esports match, or the like) at an event venue and data of input data streams from users watching an event. In this way, patterns can be deduced from the input data streams and the event activity, which patterns can indicate the times and ways in which users interact with an event using their user devices. Thus, a deduced pattern can be used to determine that an event activity is occurring or beginning to occur during an event. If thereafter the server application 300 receives input data streams including data understood from the modeling to historically correspond to such event activity (e.g., based on tag information included therein), the deduced pattern can be used to trigger a signal to cause a specified remote device operation consistent with remote operations which occurred from similar historical event activity and input data streams.

For example, a model may be generated, trained, or otherwise determined using data sets which indicate tag information and intensity data for input data streams (which also indicates trend and trend velocity information based on the tag information and intensity data being represented in a time series format), event activity occurring when those input data streams were generated, and remote operations performed based on those input data streams. The server application 300 can later monitor input data streams for similar information and compare the data of those later input data streams in a time series format against the modeled data sets to determine whether a certain trend and trend velocity is expected. In this way, the server application 300 may become aware that when some number of input data streams having certain tags with certain intensities are received, a certain remote device operation is usually performed. In some implementations, the data sets used to generate, train, or otherwise determine the model may omit information related to event activity and instead focus on measuring tag information and intensity data and matching same with remote device operations.

This predictive modeling may provide several benefits beyond simply using remote device operation reactive to input data streams. For example, predictive modeling can reduce an amount of lag occurring between user input being generated at the many user devices and the ultimate operation of a remote device at an event venue. That is, where remote device operation occurs in response to processing input data streams, there may be some amount of time which elapses before the remote device operation occurs based on the processing at the server application 300. However, where predictive modeling is used, initial trend and trend velocity measurements can be compared to modeled historical data to determine, before processing further input data streams, to perform a given remote device operation. In another example, and based on a similar rationale, a lag occurring between user input being generated at the many user devices and the ultimate return of feedback to those user devices can also be reduced using predictive modeling.

The feedback control tool 310 process remote feedback received from within the remote environment (e.g., from one or more remote devices or other devices at the event venue). The remote feedback includes data indicating the particular operation(s) performed according to the signal transmitted from the server application 300 to one or more remote devices. The feedback control tool 310 controls a use of the remote feedback data, for example, for use by the server application and/or for reporting to user devices from which input data streams were earlier received. For example, the server application 300 may use the remote feedback data to verify that remote operation of a remote device occurred, to evaluate an efficacy of the remote operation in representing viewer interaction with the user application, or for other purposes. In another example, the server application 300 may transmit some or all of the remote feedback to user devices for viewing via the user applications so that users thereof can view a precise indication of how the event venue changed based on their interactions with the user application.

In some implementations, the server application 300 may have tools in addition to or replacing ones of those shown in FIG. 3. For example, the server application 300 may further include a metrics collection tool which collects user metrics and/or tracking data from the user applications from which the input data streams are received. For example, user metrics and/or tracking data may refer to one or more of a number of interactions a user had with the user application during an event or during all events, an amount of time the user application has run on the user device, a device type or operating system installed on the user device running the user application, user demographic information, user event preference (e.g., favorite teams or other performers, favorite event occurrences, etc.) information, or the like. The user metrics and/or tracking data may be transmitted via the user application to the server application 300 separately from the input data streams which are transmitted from that user application, for example, to preserve network resource availability for the input data streams.

In another example, the server application 300 may further include a data correlation tool which correlates input data streams received through the performance of an event to occurrences at the event. For example, both numbers of data points within various input data streams as well as changes in values of those data points may be represented in time series in which a time value of the data points is compared to a time during the event. Where an occurrence of the event occurred at that time, the corresponding data points having a time value for that time may be correlated to the occurrence. The correlation may, for example, indicate viewer enthusiasm or otherwise high viewer engagement with the event due to the subject occurrence. In some such implementations, correlation information may be collected over time to evaluate and model viewer preferences for various event types. These viewer preferences may then be provided to event performers and/or to entities involved in the production of events such as to indicate the types of event occurrences which are statistically probable to result in viewer engagement during an event or to result in loss of such viewer engagement.

In some implementations, a machine learning model or other intelligence model may be used by or at the server application 300 to enable or improve functionality of the server application 300. For example, the model may look for common trends across common tags and assign specific device control outputs to unique configurations according to those commonalities. The model may thus learn by evaluating subsets of trend and tag commonalities and by finding other corollary assignments. For example, the model may learn that one or more lights at the event venue turn red when users of the user devices who are fans of a certain team express excitement (e.g., measured using an accelerometer, gyroscopic sensor, or other motion sensor of the user device), for example, when that team scores points in a match. However, where the model determines that the common tags in the trends show that the users who express that enthusiasm are all located in the United States of America, the model may configure the signal transmitted from the server device 300 to cause subsets of those lights at the event venue to instead turn one of red, white, or blue. Examples of the model include, but are not limited to, a neural network (e.g., a convolutional neural network, recurrent neural network, or other neural network), decision tree or other decision network, support vector machine, Bayesian network, genetic algorithm, deep learning system separate from a neural network, or other machine learning or intelligence model.

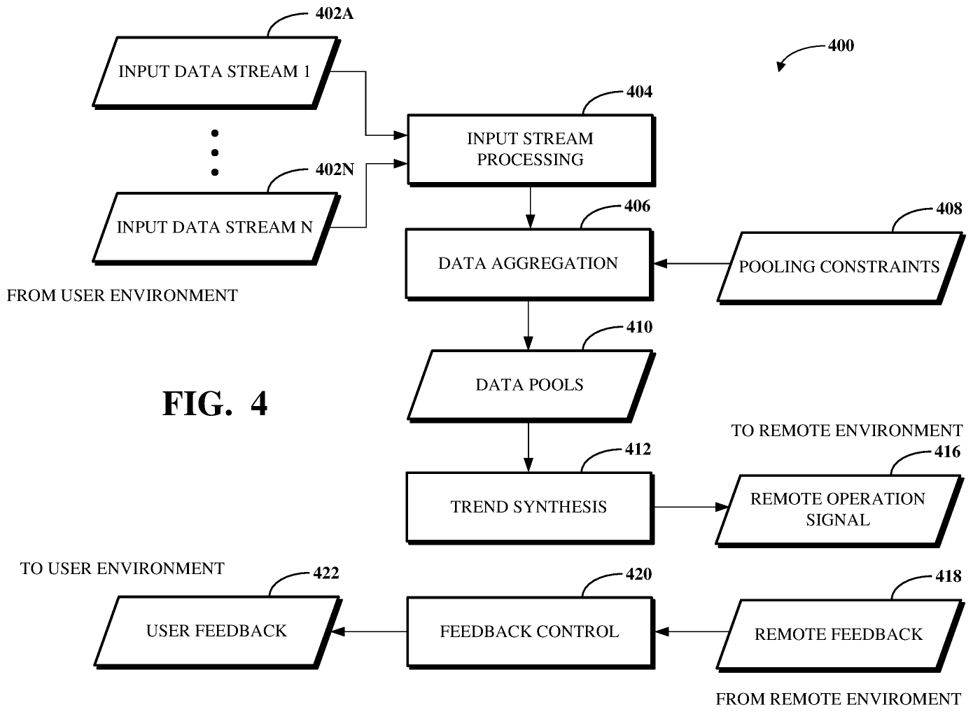

FIG. 4 is a block diagram showing an example workflow 400 of a server application used with a system for remote device operation, for example, the server application 300 shown in FIG. 3. The workflow 400 generally represents the flow of processing data from user devices, for example, the user device 208 shown in FIG. 2, at a server application to cause a remote operation of a remote device, for example, the remote device 214 shown in FIG. 2, at an event venue.

The workflow 400 begins with the receipt of input data streams 1 402A through N 402N from user devices running user applications in communication with the server application. The input data streams 1 402A through N 402N may include an input data stream for each user device in use with the system for remote device operation. An input stream processing aspect 404 enables the receipt and processing of the input data streams 1 402A through N 402N using the server application. For example, the input stream processing aspect 404 may be the input stream processing aspect 218 shown in FIG. 2.

After processing at the input stream processing aspect 404, the data of the input data streams 1 402A through N 402N are aggregated at a data aggregation aspect 406 according to pooling constraints 408 to determine data pools 410. For example, the data aggregation aspect 406 may be the data aggregation tool 304 shown in FIG. 3. The pooling constraints 408 are used to filter through the data of the input data streams 1 402A through N 402N for similarities in tag information and other information to aggregate those data into the data pools 410.

The data pools 410 are then processed using a trend synthesis aspect 412 to identify trends in the data of the data pools 410 and to determine trend velocities for those trends. For example, the trend synthesis aspect 412 may be the trend synthesis tool 306 shown in FIG. 3. Based on the trends and trend velocities, a remote operation signal 416 is generated to cause a remote operation of a remote device. For example, the trends and trend velocities may indicate increases in user interaction with the user applications over some period of time, representing a meaningful engagement of viewers of the event being performed, for example, based on an increase in reactions of the event viewers as monitored by the user applications. The remote operation signal 416 is transmitted to a remote environment to cause the remote operation.

After the remote operation is performed, remote feedback 418 is received and processed using a feedback control aspect 420. The remote feedback 418 includes information indicating the remote operation performed at the event venue according to the remote operation signal 416. For example, the feedback control aspect 420 may be the feedback control tool 310 shown in FIG. 3. Some or all of the remote feedback 418 may be passed back to some or all of the user devices as user feedback 422. In some implementations, the user feedback 422 may be omitted and thus not passed back to the user devices. For example, instead of presenting the user feedback 422 to the users of the user devices, those users may be given the opportunity to view information representative of the remote feedback 418 within a stream broadcast of the event.

The workflow 400 can be considered completed upon either the transmission of the remote operation signal 416 to the remote environment or the transmission of the user feedback 422 to the user devices. The workflow 400 may thereafter repeat as desired.

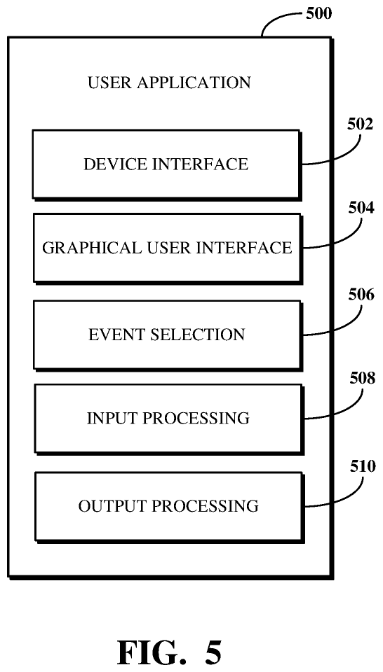

FIG. 5 is a block diagram showing examples of functionality of a user application 500 used with a system for remote device operation, for example, the user application 206 shown in FIG. 2. The user application 500 includes a device interface tool 502, a GUI tool 504, an event selection tool 506, an input processing tool 508, and an output processing tool 510.

The device interface tool 502 is a software tool for interfacing the user application 500 with the user device which runs the user application 500, for example, the user device 208 shown in FIG. 2. For example, the device interface tool 502 can include driver information and other instructions for the processing of the user application 500 at the user device. In another example, the device interface tool 502 can include interfaces enabling use of hardware components of the user device, for example, various image, video, audio, motion, and other sensors of the user device, with the user application 500.

The device interface tool 502 may further enable communications and other cross-device functionality between the user device which runs the user application 500 and other devices used with the system for remote device operation. For example, the device interface tool 502 may enable communications between the user device and a server device running a server application which processes data from the user application 500 to determine whether and how to remotely operate a remote device. The device interface tool 502 may include or otherwise use one or more application programming interfaces (APIs) associated with the server application to facilitate exchanges of information with the server application.

The GUI tool 504 is a software tool for rendering and/or displaying a GUI, such as to render or display pages, content, or other aspects of the user application 500 for use. A GUI rendered or displayed using the GUI tool 504 can comprise part of a software GUI constituting data that reflect information ultimately destined for display on a hardware device, for example, the user device 208 shown in FIG. 2). For example, the data can contain rendering instructions for bounded graphical display regions, such as windows, or pixel information representative of controls, such as buttons and drop-down menus. A structured data output of one device can be provided to an input of the hardware display so that the elements provided on the hardware display screen represent the underlying structure of the output data.

The event selection tool 506 allows a user of the user application 500 to select an event to engage with within the user application 500. The user application 500 may have information for multiple events registered with the system for remote device operation at a given time, and a user of the user application 500 may thus select which of those events he or she is viewing (e.g., on a television, computer, smartphone, etc.) so that he or she can further use the user application 500 to participate effectively as a virtual audience member. In some implementations, a user may be able to select multiple events at a given time. For example, the user application 500 in such a case may transmit input data streams for a only currently selected event at a given time.

As part of the event selection process, the event selection tool 506 may in at least some cases allow, but not require, a user of the user application 500 to input user preferences related to the selected event. For example, where the event is a sports match between two teams, the event selection tool 506 may prompt the user to indicate which of those two teams the user intends to cheer for or otherwise prefers. This user information will be used as tag information by the server application to process input data streams received during the subject event.

The input processing tool 508 processes inputs to the user application 500 to generate input data streams for transmission to the server application. The input processing tool 508 can use sensors of the user device to measure the inputs and generate an input data stream at a given time based thereon. The input processing tool 508 may further pre-process the measured inputs to prevent false positive data from being included in an input data stream. For example, the input processing tool 508 may apply some threshold requirement corresponding to a minimum engagement level to the measured inputs. If the measured inputs meet the threshold requirement, they are included in an input data stream; otherwise, they may be discarded. The specific amount of the threshold requirement may be based on the type of measured input. For example, where the measured input is motion measured using an accelerometer or gyroscopic sensor of the user device, the specific amount may represent an acceleration value of the user device unlikely to have resulted from an unintentional interaction with the user application.

The output processing tool 510 processes information which may be rendered or displayed with a GUI of the user application 500. For example, the output processing tool 510 may process information about the event received from the server application, such as user feedback indicating the remote operations performed at the event venue based on the input data streams transmitted from the user application 500. This user feedback may assist in keeping the user of the user application 500 further engaged during the event. In another example, the output processing tool 510 may process information configured to prompt a user of the user application 500 to enter input, such as prompts asking the user for his or her favorite performer, which of the teams in a sports match or e-sports match the user is cheering for, or the like.

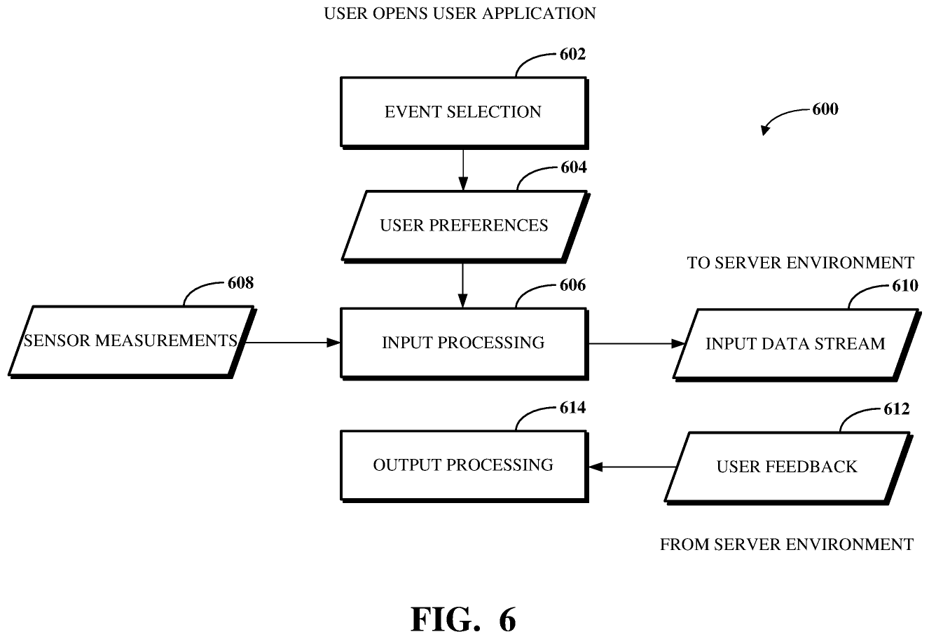

FIG. 6 is a block diagram showing an example workflow 600 of a user application used with a system for remote device operation, for example, the user application 500 shown in FIG. 5. The workflow 600 generally represents the flow of processing data from a user application run on a user device, for example, the user device 208 shown in FIG. 2, to a server application which processes that data to cause a remote operation of a remote device, for example, the remote device 214 shown in FIG. 2, at an event venue.

The workflow 600 begins after the user of a user device opens the user application, with the user selecting an event at an event selection aspect 602 of the user application. For example, the event selection aspect 602 may be the event selection tool 506 shown in FIG. 5. The event may be one of many selectable events available through the user application. After selecting the event the user wishes to engage with using the user application, user preferences 604 are obtained. The user preferences 604 may be obtained by the user entering them into the user application, for example, responsive to a prompt therefore by the user application or otherwise within fields used for user preference collection. Alternatively, the user preferences 604 may be obtained from a data record associated with the user, for example, where the user has previously indicated those user preferences directly or indirectly.

The workflow 600 then proceeds to an input processing aspect 606, which uses the user preferences 604 and sensor measurements 608 obtained using one or more sensors or other components of the user device to generate an input data stream 610 to be transmitted to a server environment. For example, the input processing aspect 606 may be the input processing tool 508 shown in FIG. 5. The input processing aspect 606 obtains the sensor measurements 608 in response to some user interaction with the user device via the user application, for example, by shaking the user device or otherwise exposing it to some amount of motion, by presenting a particular gesture or facial depiction for imaging, by making a specific sound or other noise, or by another way of interacting using a sensor or component of the user device. The data obtained within the sensor measurements 608 are tagged using the user preferences 604 and/or user demographic information to produce the input data stream 610.

After the input data stream 610 is used by a server application which receives as part of a process for remote operation of a remote device at the event venue, user feedback 612 is received from the server environment to indicate that remote operation. An output processing aspect 614 may make some or all of the user feedback 612 available for user review within the user application. For example, the output processing aspect 614 may be the output processing tool 510 shown in FIG. 5. In some implementations, the user feedback 612 may be omitted and thus not be made directly available for user review within the user application. For example, instead of presenting the user feedback 612 to the users of the user devices, those users may be given the opportunity to view information representative of the remote operation within a stream broadcast of the event.

The workflow 600 can be considered completed upon either the transmission of the input data stream 610 to the server environment or the processing or other review of the user feedback 612 using the output processing aspect 614. The workflow 600 may thereafter repeat as desired.

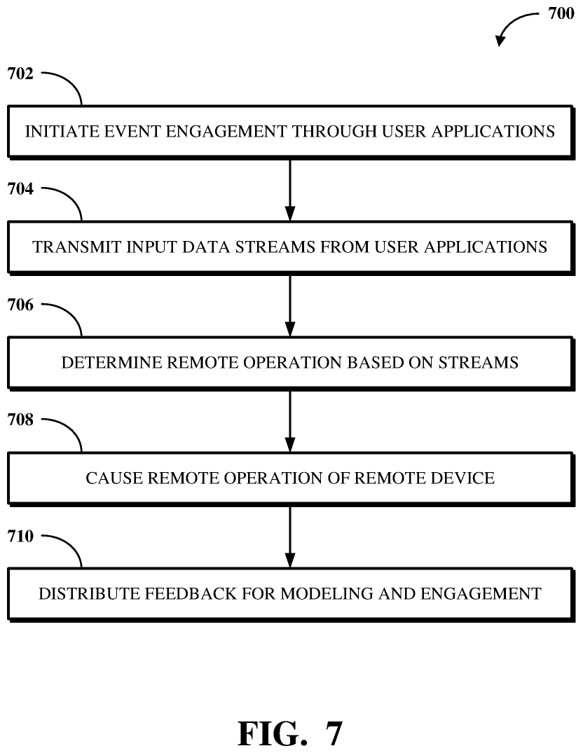

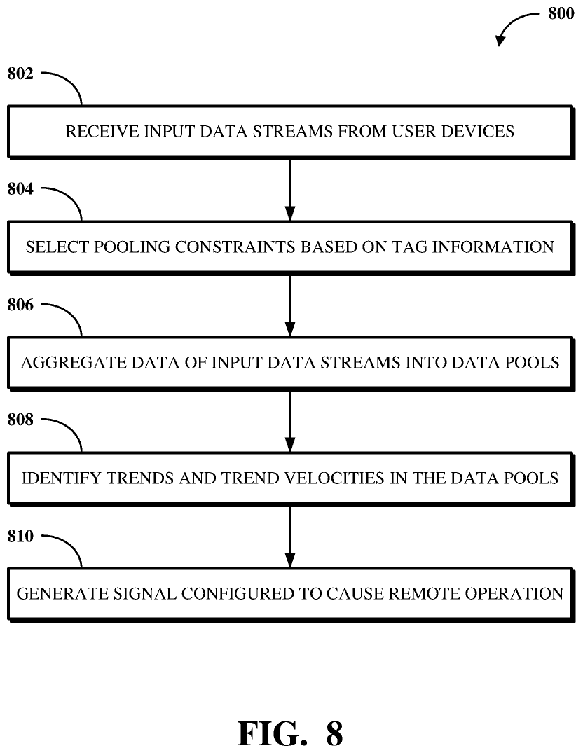

To further describe some implementations in greater detail, reference is next made to examples of techniques which may be performed by or using a system for remote device operation as described with respect to FIGS. 1-6. FIG. 7 is a flowchart showing an example of a technique 700 for remote device operation using data stream aggregations. FIG. 8 is a flowchart showing an example of a technique 800 for input data stream aggregation and synthesis.

The technique 700 and/or the technique 800 can be executed using computing devices, such as the systems, hardware, and software described with respect to FIGS. 1-6. The technique 700 and/or the technique 800 can be performed, for example, by executing a machine-readable program or other computer-executable instructions, such as routines, instructions, programs, or other code. The steps, or operations, of the technique 700 and/or the technique 800, or another technique, method, process, or algorithm described in connection with the implementations disclosed herein, can be implemented directly in hardware, firmware, software executed by hardware, circuitry, or a combination thereof.

For simplicity of explanation, the technique 700 and the technique 800 are each depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Referring first to FIG. 7, the technique 700 for remote device operation using data stream aggregations is shown. At 702, an event engagement is initiated for users of various user devices through user applications running on those user devices. At 704, input data streams generated at or otherwise using those user applications are transmitted to a server application for processing. At 706, a remote operation to perform for a remote device located at an event venue of the event for which the user is engaged is determined using those input data streams. At 708, the remote operation of the remote device is caused. At 710, feedback related to the remote operation of the remote device is received and distributed in whole or in part for modeling further input data stream processing and/or for enhancing user engagement with the event.

Referring next to FIG. 8, the technique 800 for input data stream aggregation and synthesis is shown. At 802, input data streams are received from user devices, specifically, from user applications at which those input data streams are disparately generated. At 804, pooling constraints to use for aggregating data of the input data streams are selected based on tag information of those input data streams. At 806, data of the input data streams are aggregated according to the pooling constraints to determine data pools. At 808, trends and trend velocities in the data pools are associated to indicate user engagement with the user applications relative to certain occurrences during the event or otherwise relative to certain prompts to the users during the event. At 810, a signal configured to cause a remote operation of a remote device is generated according to the trends and trend velocities.

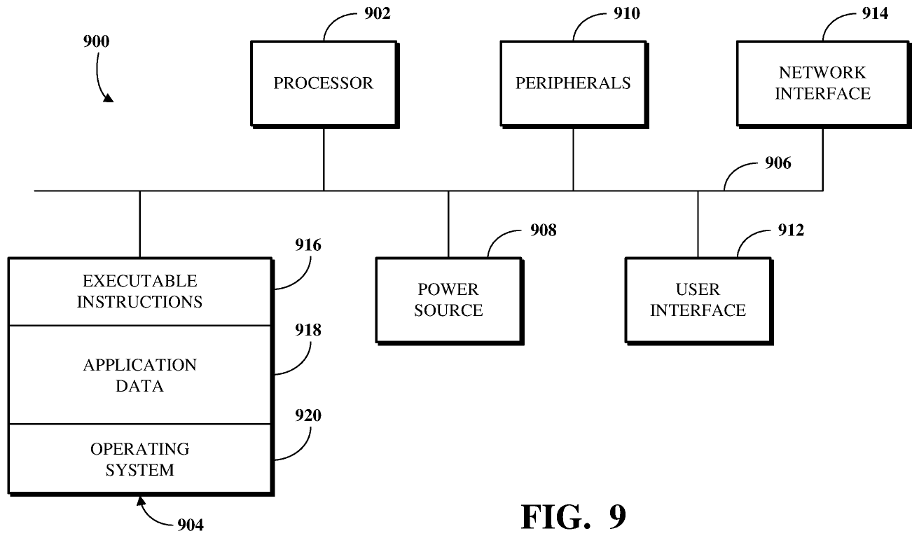

FIG. 9 is a block diagram showing an example of a computing device 900 which may be used in a system for remote device operation, for example, the system 100 shown in FIG. 1. The computing device 900 may be used to implement a software application used with the system for remote device operation, for example, the server application 200, the user application 206, or the remote application 212 shown in FIG. 2. Alternatively, the computing device 900 may be used to implement a client that accesses the software application. As a further alternative, the computing device 900 may be used as or to implement another client, server, or other device according to the implementations disclosed herein.

The computing device 900 includes components or units, such as a processor 902, a memory 904, a bus 906, a power source 908, peripherals 910, a user interface 912, and a network interface 914. One of more of the memory 904, the power source 908, the peripherals 910, the user interface 912, or the network interface 914 can communicate with the processor 902 via the bus 906.

The processor 902 is a central processing unit, such as a microprocessor, and can include single or multiple processors having single or multiple processing cores. Alternatively, the processor 902 can include another type of device, or multiple devices, now existing or hereafter developed, configured for manipulating or processing information. For example, the processor 902 can include multiple processors interconnected in any manner, including hardwired or networked, including wirelessly networked. For example, the operations of the processor 902 can be distributed across multiple devices or units that can be coupled directly or across a local area or other suitable type of network. The processor 902 can include a cache, or cache memory, for local storage of operating data or instructions.

The memory 904 includes one or more memory components, which may each be volatile memory or non-volatile memory. For example, the volatile memory of the memory 904 can be random access memory (RAM) (e.g., a DRAM module, such as DDR SDRAM) or another form of volatile memory. In another example, the non-volatile memory of the memory 904 can be a disk drive, a solid state drive, flash memory, phase-change memory, or another form of non-volatile memory configured for persistent electronic information storage. The memory 904 may also include other types of devices, now existing or hereafter developed, configured for storing data or instructions for processing by the processor 902. In some implementations, the memory 904 can be distributed across multiple devices. For example, the memory 904 can include network-based memory or memory in multiple clients or servers performing the operations of those multiple devices.

The memory 904 can include data for immediate access by the processor 902. For example, the memory 904 can include executable instructions 916, application data 918, and an operating system 920. The executable instructions 916 can include one or more application programs, which can be loaded or copied, in whole or in part, from non-volatile memory to volatile memory to be executed by the processor 902. For example, the executable instructions 916 can include instructions for performing some or all of the techniques of this disclosure. The application data 918 can include user data, database data (e.g., database catalogs or dictionaries), or the like. In some implementations, the application data 918 can include functional programs, such as a web browser, a web server, a database server, another program, or a combination thereof. The operating system 920 can be, for example, Microsoft Windows®, Mac OS X®, or Linux®; an operating system for a small device, such as a smartphone or tablet device; or an operating system for a large device, such as a mainframe computer.

The power source 908 includes a source for providing power to the computing device 900. For example, the power source 908 can be an interface to an external power distribution system. In another example, the power source 908 can be a battery, such as where the computing device 900 is a mobile device or is otherwise configured to operate independently of an external power distribution system.

The peripherals 910 includes one or more sensors, detectors, or other devices configured for monitoring the computing device 900 or the environment around the computing device 900. For example, the peripherals 910 can include a geolocation component, such as a global positioning system location unit. In another example, the peripherals can include a temperature sensor for measuring temperatures of components of the computing device 900, such as the processor 902. In some implementations, the computing device 900 can omit the peripherals 910.

The user interface 912 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 914 provides a connection or link to a network (e.g., the network 106 shown in FIG. 1). The network interface 914 can be a wired network interface or a wireless network interface. The computing device 900 can communicate with other devices via the network interface 914 using one or more network protocols, such as using Ethernet, TCP, IP, power line communication, Wi-Fi, Bluetooth, infrared, GPRS, GSM, CDMA, Z-Wave, ZigBee, another protocol, or a combination thereof.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc.

Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for remote device operation using data stream aggregations, the method comprising:
initiating, within a user application running at a user device, a user engagement with an event occurring at an event venue;
generating, at the user application during a performance of the event, an input data stream representative of a user interaction with the user application, wherein the user interaction corresponds to a reaction of the user to an occurrence within the event;
transmitting, from the user device, the input data stream to a server device running a server application configured to continuously receive multiple other input data streams from multiple user devices during the event;
determining data pools by aggregating, at the server application, data of the input data stream and data of at least some of the multiple other input data streams according to one or more pooling constraints associated with tag information included in the input data stream and the at least some of the multiple other input data streams;
synthesizing, at the server application, trends and trend velocities within the data pools to determine to cause an operation of a function of a remote device located at the event venue during the event; and
transmitting, from the server device, a signal to the remote device, wherein the signal is configured to cause the operation of the function of the remote device according to the trends and the trend velocities.

2. The method of claim 1, wherein initiating the user engagement with the event comprises:
receiving, within the user application, a selection by the user of the user application of the event from a list of events registered with the user application; and
obtaining user preferences responsive to the selection of the event by the user.

3. The method of claim 2, wherein generating the input data stream comprises:
obtaining sensor measurements representative of the user interaction with the user application from one or more sensors of the user device; and
tagging data of the sensor measurements using the tag information, wherein the tag information includes the user preferences and user demographic information for the user.

4. The method of claim 3, wherein the one or more sensors includes a motion sensor of the user device, and wherein the user interaction with the user application refers to a motion of the user device recorded using the motion sensor.

5. The method of claim 1, wherein the remote device is one of a lighting device, an audio device, a video rendering device, an image rendering device, or a haptic device.

6. The method of claim 1, further comprising:
receiving, from the remote device, remote feedback at the server application, wherein the remote feedback is representative of the operation of the remote device; and
modeling further data aggregation or trend synthesis at the server application according to the remote feedback.

7. The method of claim 6, further comprising:
transmitting, from the server device, at least some of the remote feedback to the user device to configure the user application to output the at least some of the remote feedback for review by the user.

8. The method of claim 1, wherein the event venue includes multiple remote devices each corresponding to a user application running on one of the multiple user devices, wherein the multiple remote devices include the remote device and the multiple user devices include the user device, and wherein the signal is configured to cause individual operation of each of the multiple remote devices according to the data of the input data streams received from respective ones of the multiple user devices.

9. A non-transitory computer readable medium storing instructions that, when executed by one or more processors, cause a performance of operations for remote device operation using data stream aggregations, the operations comprising:
initiating, within a user application running at a user device, a user engagement with an event occurring at an event venue;
generating, at the user application during a performance of the event, an input data stream representative of a user interaction with the user application, wherein the user interaction corresponds to a reaction of the user to an occurrence within the event;
transmitting, from the user device, the input data stream to a server device running a server application configured to continuously receive multiple other input data streams from multiple user devices during the event;
determining data pools by aggregating, at the server application, data of the input data stream and data of at least some of the multiple other input data streams according to one or more pooling constraints associated with tag information included in the input data stream and the at least some of the multiple other input data streams;
synthesizing, at the server application, trends and trend velocities within the data pools to determine to cause an operation of a function of a remote device located at the event venue during the event; and
transmitting, from the server device, a signal to the remote device, wherein the signal is configured to cause the operation of the function of the remote device according to the trends and the trend velocities.

10. An apparatus for remote device operation using data stream aggregations, the operations comprising:
a memory; and
a processor configured to execute instructions stored in the memory to:
initiate, within a user application running at a user device, a user engagement with an event occurring at an event venue;
generate, at the user application during a performance of the event, an input data stream representative of a user interaction with the user application, wherein the user interaction corresponds to a reaction of the user to an occurrence within the event;
transmit, from the user device, the input data stream to a server device running a server application configured to continuously receive multiple other input data streams from multiple user devices during the event;
determine data pools by aggregating, at the server application, data of the input data stream and data of at least some of the multiple other input data streams according to one or more pooling constraints associated with tag information included in the input data stream and the at least some of the multiple other input data streams;
synthesize, at the server application, trends and trend velocities within the data pools to determine to cause an operation of a function of a remote device located at the event venue during the event; and
transmit, from the server device, a signal to the remote device, wherein the signal is configured to cause the operation of the function of the remote device according to the trends and the trend velocities.
